(19) United States
(12) Patent Application Publication
(10) Pub. No.: US 2018/0019802 A1
(43) Pub. Date: Jan. 18, 2018

(54) Managing Network Communication of a Drone

(71) Applicant: QUALCOMM Incorporated, San Diego, CA (US)

(72) Inventor: Edward Harrison Teague, San Diego, CA (US)

(21) Appl. No.: 15/340,488

(22) Filed: Nov. 1, 2016

Related U.S. Application Data
(60) Provisional application No. 62/362,820, filed on Jul. 15, 2016.

(51) Int. Cl. H04B 7/185; H04L 12/24; H04L 29/06

(52) U.S. Cl. CPC H04B 7/18506; H04L 63/08; H04L 41/0803; H04L 41/5022; H04L 63/06

(57) ABSTRACT

Various embodiments include methods of managing network communication of a drone. The methods may include determining which type of at least two types of communications to classify a communication designated for transmission to or from the drone. The at least two types of communications may include operational safety communications and payload communications. A communication service configuration may be assigned based on the determined type of communications. The communications to or from the drone may be transmitted using the assigned communication service configuration.

### RELATED APPLICATIONS

This application claims the benefit of priority to U.S. Provisional Patent Application 62/362,820 entitled “Managing Network Communication of an Unmanned Autonomous Vehicle,” filed Jul. 15, 2016, the entire contents of which are incorporated herein by reference.

### BACKGROUND

Drones, or unmanned autonomous/semi-autonomous vehicles, generally require connectivity services for two disparate types of communications, namely operational safety communications and payload communications. The operational safety communications relate to drone safety, integrity, and/or security. In contrast, payload communications involve other communications that do not relate directly to the safety and/or security of the drone. Often these two disparate types of communications have conflicting needs, thus supporting both types of communications on the same wireless network can be problematic.

### SUMMARY

Various embodiments include methods of managing network communication of a drone. The methods may include determining a type of a communication designated for transmission to or from the drone. The determined type of the communication may be one of at least two types of communications including a first type of communications for operational safety communications and a second type of communications for payload communications. A communication service configuration may be assigned based on the determined type of the communication.

In various embodiments, the assigned communication service configuration may include a first configuration in response to the determined type of the communication being the first type of communications, and a second configuration different from the first configuration in response to the determined type of the communication being the second type of communications. The first configuration may include at least one of a first authentication mechanism or first security credentials and the second configuration may include at least one of a second authentication mechanism or second security credentials. The communication designated for transmission to or from the drone may be transmitted using the assigned communication service configuration.

In various embodiments, the assigned communication service configuration may include a first quality of service designation for the first type of communications and a second quality of service designation for the second type of communications.

In various embodiments, assigning the communication service configuration may include dedicating one or more communication resources to the transmission of the communication in order to increase a likelihood that the communication will be successfully completed. Assigning the communication service configuration may include assigning a priority to the first type of communications over the second type of communications based on the determined type of the communication. The drone may be configured to use a single drone radio for transmitting both of the at least two types of communications.

In various embodiments, determining the type of the communication designated for transmission may include identifying data within the communication that indicates the type of the communication. Determining the type of the communication designated for transmission may include identifying an application associated with the communication that indicates the type of the communication.

In various embodiments, transmitting the communication using the assigned communication service configuration may include using prioritized scheduling giving the communication a first level of priority in response to the determined type of the communication being the first type of communications, and giving the communication a second level of priority different from the first level of priority in response to the determined type of the communication being the second type of communications. Transmitting the communication using the assigned communication service configuration may include using punctured resource scheduling that inserts the communication within or along with an in-progress transmission. Transmitting the communication using the assigned communication service configuration may include transmitting a network message for activating multi-cell coordination configured to increase a likelihood the communication is received by the drone, if transmitted to the drone, or received from the drone, if transmitted by the drone.

In various embodiments, the assigned communication service configuration may include the first authentication mechanism that includes at least one of a secure key exchange, a key validation, or a communication channel setup for credential tests. The assigned communication service configuration may include the first authentication mechanism that includes a randomized split key. The assigned communication service configuration may include the first security credentials that include at least one of a text-based communication or an access code. The assigned communication service configuration may include the first security credentials that include data derived from at least one of a physical or biometric feature.

Further embodiments may include a computing device, remote from the drone, including a transceiver and a processor configured to perform operations of the methods summarized above. Further embodiments may include a drone including a transceiver and a processor configured to perform operations of the methods summarized above.

Further embodiments include a drone and/or a remote computing device having means for performing functions of the methods summarized above. Further embodiments include a non-transitory processor-readable storage medium having stored thereon processor-executable instructions configured to cause a processor to perform operations of the methods summarized above.

### BRIEF DESCRIPTION OF THE DRAWINGS

The accompanying drawings, which are incorporated herein and constitute part of this specification, illustrate exemplary embodiments of the claims, and together with the general description and the detailed description given herein, serve to explain the features of the claims.

FIG. 1 is a system block diagram of a communication system according to various embodiments.

FIG. 2 is a component block diagram illustrating components of a drone according to various embodiments.

FIG. 3 is a component block diagram illustrating components of a drone mission controller according to various embodiments.

FIG. 4 is a component block diagram illustrating components of a drone operations controller according to various embodiments.

FIG. 5 is a process flow diagram illustrating a method for managing network communication of a drone according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable a network, or a drone communicating with the network, to use different communication service configurations for different types of communications even though the service is provided through a single communication system of the drone. The different types of communications may distinguish operational safety communications from payload communications. The different communication service configurations may include a multiplicity of service configurations, including different quality of service (QoS) designations, authentication mechanisms, and/or security credentials. Thus, various embodiments may enable a single communication system, such as one having a single radio and/or antenna, to regulate and/or manage different types of communications of or with a drone.

As used herein, the term “drone” refers to one of various types of autonomous or semi-autonomous vehicles (e.g., aircraft, land vehicles, waterborne vehicles, or a combination thereof) that may operate without onboard human pilots/drivers. A drone may include an onboard computing device configured to fly and/or operate the drone without remote operating instructions (i.e., autonomously), such as from a human operator or remote computing device. Alternatively or additionally, the computing device onboard the drone may be configured to receive operating instructions and/or updates to instructions from a remote computing device via communications in accordance with various embodiments. A drone may be propelled for flight and/or other movement in any of a number of known ways. For example, a plurality of propulsion units, each including one or more rotors, may provide propulsion or lifting forces for the drone and any payload carried by the drone. In addition, the drone may include wheels, tank-treads, or other non-aerial movement mechanisms to enable movement on the ground, over water, under water, or a combination thereof Further, the drone may be powered by one or more types of power source, such as electrical, chemical, electro-chemical, or other power reserve, which may power the propulsion units, the onboard computing device, and/or other onboard components.

The term “computing device” is used herein to refer to an electronic device equipped with at least a processor. Examples of computing devices may include a drone mission controller, mission management computers, a drone operations controller, mobile devices (e.g., cellular telephones, wearable devices, smart-phones, web-pads, tablet computers, Internet enabled cellular telephones, Wi-Fi® enabled electronic devices, personal data assistants (PDAs), laptop computers, etc.), personal computers, and server computing devices. In various embodiments, computing devices may be configured with memory and/or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® or Bluetooth transceiver, etc.).

The term “server” as used herein refers to any computing device capable of functioning as a server, such as a master exchange server, web server, and a personal or mobile computing device configured with software to execute server functions (e.g., a “light server”). Thus, various computing devices may function as a server, such as any one or all of cellular telephones, smart-phones, web-pads, tablet computers, Internet enabled cellular telephones, WAN enabled electronic devices, laptop computers, personal computers, and similar electronic devices equipped with at least a processor, memory, and configured to communicate with a drone. A server may be a dedicated computing device or a computing device including a server module (e.g., running an application that may cause the computing device to operate as a server). A server module (or server application) may be a full function server module, or a light or secondary server module (e.g., light or secondary server application). A light server or secondary server may be a slimmed-down version of server type functionality that can be implemented on a personal or mobile computing device, such as a smart phone, thereby enabling it to function as an Internet server (e.g., an enterprise e-mail server) to a limited extent, such as necessary to provide the functionality described herein. An example of server suitable for use with the various embodiments is described with reference to FIG. 4.

As used herein, the term “operational safety communications” refers to drone communications that relate to drone safety, integrity, and/or security. Operational safety communications may involve telemetry carrying override control commands and drone status information exchanged between the drone and a ground station designated to maintain control and/or safety of the drone. For example, the drone status information may include data regarding the drone's current location, current activities, resource status levels (e.g., power supply levels), and even imaging or sensor data related to mission-critical and or safety operations. Additionally, operational safety communications may relate to local air traffic, navigational commands, navigational patterns, or other operational safety information. Since operational safety communications allow the drone to receive safety messages and/or instructions that should be received with minimal latency, the operational safety communications must generally comply with specific high-level reliability and regulatory compliance requirements. The ground station designated to maintain control and/or safety of the drone may be an entity or private/commercial organization in charge of the drone (e.g., a drone fleet manager) or a government and/or regulatory agency tasked to ensure operational safety.

As used herein, the term “payload communications” refers to drone communications that relate to other communications that are not considered operational safety communications of the drone. For example, payload communications may include communications with equipment on the drone for managing one or more mission objectives, other than navigating and operational safety. For example, payload communications may configure a sensor payload for measurements (e.g., agricultural crop yield measurements in agricultural settings) or download collected data files (e.g., video recordings unrelated to vehicle control or safety). Often, the payload communications drive the purpose for operation of a drone but may be completely unrelated to operating the drone safely or securely. Thus, the payload communications may be directed or managed by a completely different entity than the operational safety communications.

Navigation control systems are being integrated for simplicity and weight, which may lead to extended drone operating times. However, different navigation control systems are often supported by different types of communications and/or may vary in communication service requirements. Also, government regulations may require a higher level of connectivity or reliability for regulated communications as compared to non-regulated communications like payload communications. Thus, being able to differentiate different types of communications while using a single communication network technology may have advantages.

In various embodiments, a processor in drone, or a processor communicating with a drone, may meet regulatory reliability requirements by maintaining a connection to a regulated operational safety control system, while simultaneously providing connectivity for payload (nonessential) communications. Also, in various embodiments, a drone equipped with only a single radio (e.g., a single LTE modem) may be able to selectively distinguish, transmit, and/or receive communications that carry two different types of communications. In various embodiments, the processor may further distinguish between different types of data within one or both of the two types of communications, namely operational safety communications and payload communications.

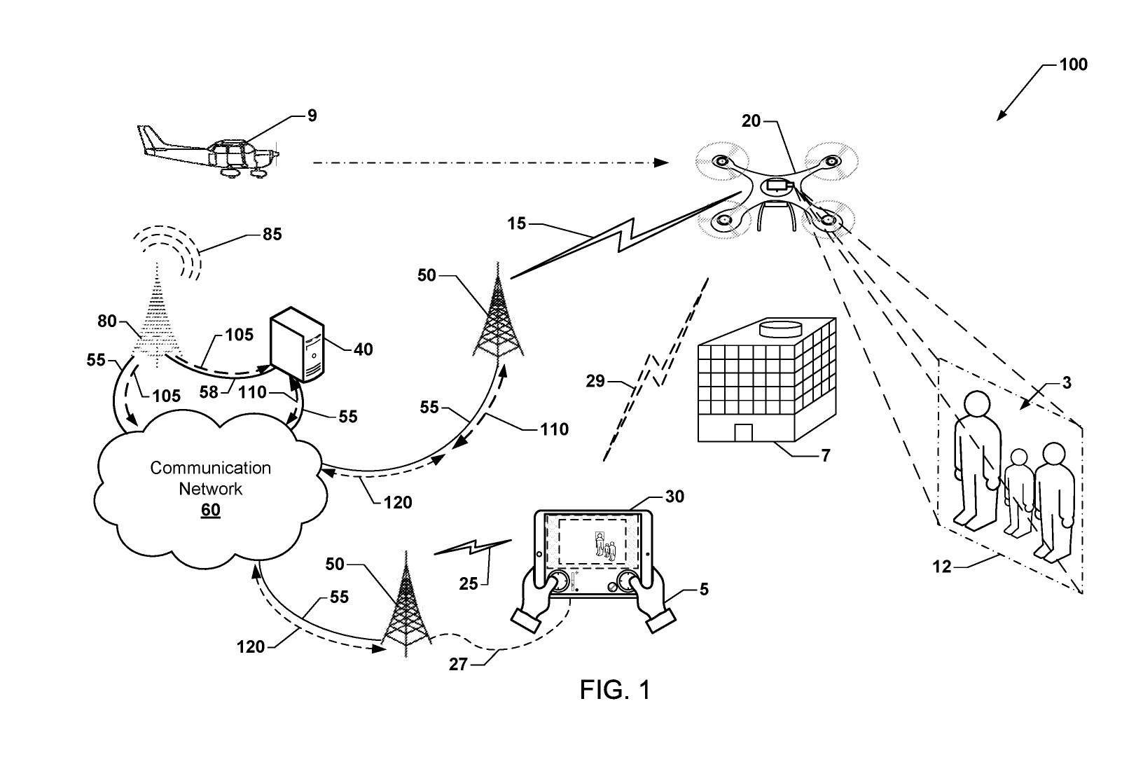

Various embodiments may be implemented within a variety of communication systems 100, an example of which is illustrated in FIG. 1. With reference to FIG. 1, the communication system 100 may include a drone 20, a drone mission controller 30, a drone operations controller 40, one or more base stations 50, and a communication network 60.

The base station 50 may provide a wireless connection 15 between the drone 20 and the communication network 60 over a wired and/or wireless communications connection 55. The base station 50 may include a computing device configured to provide wireless communications over a wide area (e.g., macro cells), as well as small cells or a wireless access points, which may include a microcell, a femtocell, a picocell, a Wi-Fi access point, and/or other similar network access points. The communication network 60 may in turn provide access to other remote base stations 50 over the same or another wired and/or wireless communications connection 55. In addition, the communication network 60 may provide the drone 20 access to the drone operations controller 40, which may also be coupled thereto.

The drone 20 may be configured to communicate with the drone mission controller 30 for receiving operational safety communications 110 and/or payload communications 120. The drone mission controller 30 may communicate with the drone 20 using long-range communications such as through a wireless connection 25 to the base station 50 that may access the communication network 60. Alternatively, the drone mission controller 30 may use a wired connection 27 to access the communication network 60 via the base station 50. Additionally and/or as a further alternative the drone mission controller 30 may communicate with the drone 20 using a direct wireless connection 29.

The drone mission controller 30 may be used primarily for payload communications with the drone 20. An operator 5 of the drone mission controller 30 may be in charge of a drone mission, which may be a reason the drone 20 is being used. For example, the drone mission may involve taking photographs or video 12 of subjects 3, which photographs or video 12 may be communicated from the drone 20 back to the drone mission controller 30. Additionally or alternatively, the drone mission controller 30 may communicate operational safety communications, such as rerouting information to avoid obstacles 7. Although the drone mission controller 30 is illustrated as being held by a human operator 5, the drone mission controller 30 may be operated by an automated system or a combination of the automated system and the operator 5.

Each wireless connection 15, 25, 29 may include a plurality of carrier signals, frequencies, or frequency bands, each of which may include a plurality of logical channels. The wireless connections 15, 25, 29 may utilize one or more radio access technologies (RATs), which may be same as or different from one another. Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, Multefire, and relatively short range RATs such as ZigBee, Bluetooth, and Bluetooth Low Energy (LE).

The drone operations controller 40 may be used primarily for operational safety communications with the drone 20, although, in some embodiments, the drone operations controller 40 may also be used for payload communications. The drone operations controller 40 may receive telemetry from or transmit data to the drone 20. For example, the drone operations controller 40 may provide hazard avoidance information to the drone 20. The drone operations controller 40 may be included in or part of a manned aviation information system, which tracks the air traffic 9 using remote observation stations 80 and air traffic detection systems 85 in communication with the drone operations controller 40, to communicate air traffic warnings, controls, overrides, or other operational safety communications to the drone 20. The drone operations controller may receive information 105 from the remote observation stations 80 via either the wired and/or wireless communications connection 55 to the communication network or a direct communication link 58. Additionally or alternatively, the drone may be configured to detect the presence of the air traffic 9 using onboard sensors (e.g., a camera, a radio frequency signal sensor, or another similar sensor) and transmit that information to the drone operations controller 40. The drone operations controller 40 may also provide information about weather conditions to the drone 20.

Although only a single one of the drone operations controller 40 is shown in the communication system 100, the information described herein as being maintained and/or managed by the drone operations controller 40 may be distributed among many servers. Alternatively or additionally, the servers may be redundant, so that the drone 20 may be configured to communicate with a selected one of the servers. The selection of a server with which to communicate may be based on a criteria or condition, such as the type of the communication designated for transmission, the proximity of the server to the drone 20, the wireless link quality between the server and the drone 20, an affiliation or classification of the server (e.g., military, government, commercial, private, etc.), a reputation of the server, an operator of the server, and so on.

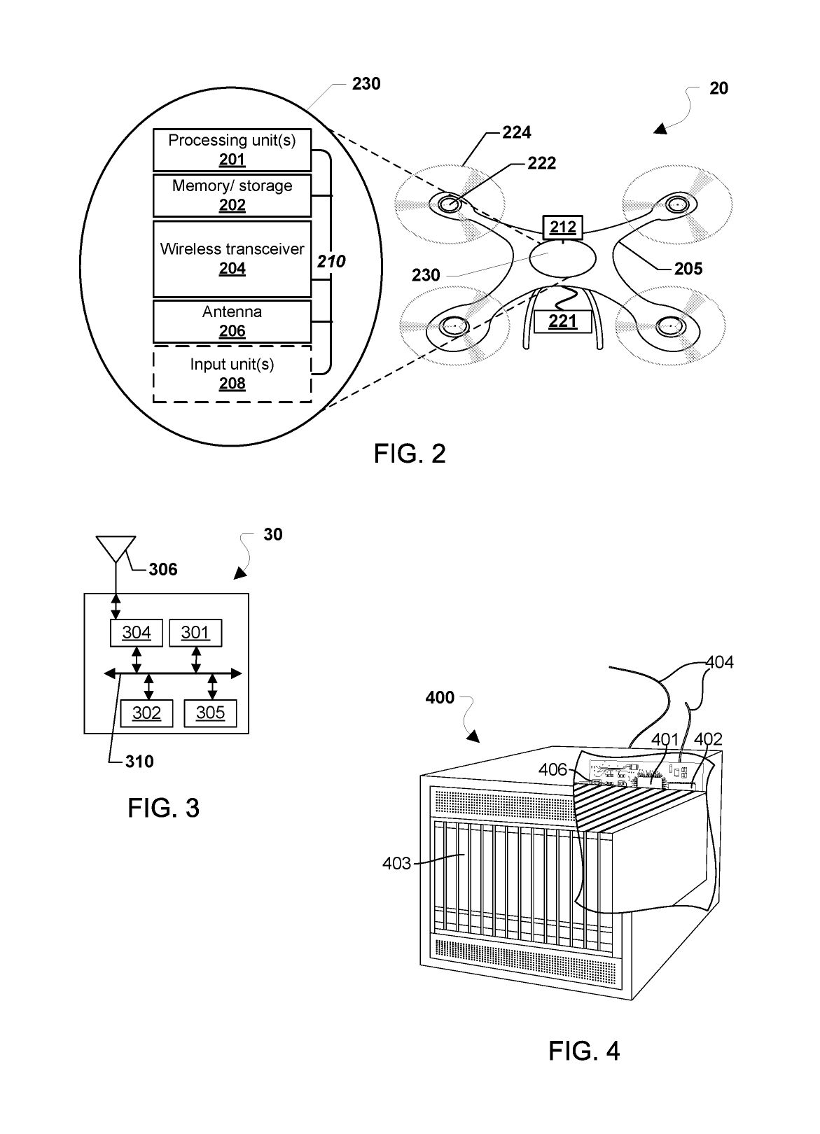

Various embodiments may be implemented within a variety of drones, an example of which is a four-rotor drone, as illustrated in FIG. 2, which is suitable for use with various embodiments. With reference to FIGS. 1 and 2, the drone 20 may include a body 205 (i.e., fuselage, frame, etc.) that may be made out of any combination of plastic, metal, or other materials suitable for flight. Various embodiments may also be implemented with other types of drones, including other types of autonomous aircraft, land vehicles, waterborne vehicles, or a combination thereof.

The body 205 may include a processor 230 that is configured to monitor and control the various functionalities, subsystems, and/or other components of the drone 20. For example, the processor 230 may be configured to monitor and control various functionalities of the drone 20, such as any combination of modules, software, instructions, circuitry, hardware, etc. related to propulsion, navigation, power management, sensor management, and/or stability management.

The processor 230 may include one or more processing unit(s) 201, such as one or more processors configured to execute processor-executable instructions (e.g., applications, routines, scripts, instruction sets, etc.) to control flight and other operations of the drone 20, including operations of various embodiments. In some embodiments, the processor 230 may be coupled to a memory unit 202 configured to store data (e.g., flight plans, obtained sensor data, received messages, applications, etc.).

In various embodiments the processor 230 may be coupled to communication resources, including a wireless transceiver 204 and antenna 206 for transmitting and receiving wireless signals (e.g., a Wi-Fi® radio and antenna, Bluetooth®, etc.). Because drones often fly at low altitudes (e.g., below 400 feet), the drone 20 may scan for wireless wide area network (WWAN) communication signals (e.g., Wi-Fi signals, Bluetooth signals, cellular signals, etc.) associated with transmitters (e.g., beacons, Wi-Fi access points, Bluetooth beacons, small cells (picocells, femtocells, etc.), etc.) such as beacons or other signal sources within restricted or unrestricted areas near or on a flight path. The communication resources may receive data from radio nodes, such as navigation beacons (e.g., very high frequency (VHF) omnidirectional range (VOR) beacons), Wi-Fi access points, cellular network base stations, radio stations, etc.

Drones may navigate using navigation systems, such as Global Navigation Satellite System (GNSS), Global Positioning System (GPS), etc. In some embodiments, the drone 20 may use an alternate source of positioning signals (i.e., other than GNSS, GPS, etc.). The drone 20 may use location information associated with the source of the alternate signals together with additional information (e.g., dead reckoning in combination with last trusted GNSS/GPS location, dead reckoning in combination with a position of the drone takeoff zone, etc.) for positioning and navigation in some applications. Thus, the drone 20 may navigate using a combination of navigation techniques, including dead-reckoning, camera-based recognition of the land features below and around the drone 20 (e.g., recognizing a road, landmarks, highway signage, etc.), etc. that may be used instead of or in combination with GNSS/GPS location determination and triangulation or trilateration based on known locations of detected wireless access points.

In some embodiments, the processor 230 of the drone 20 may further include various input units 208 for receiving control instructions, data from human operators or automated/pre-programmed controls, and/or for collecting data indicating various conditions relevant to the drone 20. For example, the various input units 208 may include camera(s), microphone(s), sensor(s), location information functionalities (e.g., a global positioning system (GPS) receiver for receiving GPS coordinates), flight instruments (e.g., attitude indicator(s), gyroscope(s), accelerometer(s), altimeter(s), compass(es), etc.), keypad(s), etc. The various components of the processor 230 may be connected via a bus 210 or other similar circuitry.

The body 205 may include landing gear of various designs and purposes, such as legs, skis, wheels, pontoons, etc. The body 205 may also include a payload mechanism 221 configured to hold, hook, grasp, envelope, and otherwise carry various payloads, such as boxes. In some embodiments, the payload mechanism 221 may include and/or be coupled to actuators, tracks, rails, ballasts, motors, and other components for adjusting the position and/or orientation of the payloads being carried by the drone 20. For example, the payload mechanism 221 may include a box moveably attached to a rail such that payloads within the box may be moved back and forth along the rail. The payload mechanism 221 may be coupled to the processor 230 and thus may be configured to receive configuration or adjustment instructions. For example, the payload mechanism 221 may be configured to engage a motor to re-position a payload based on instructions received from the processor 230.

Drones may be winged or rotor craft varieties. For example, the drone 20 may be a rotary propulsion design that utilizes one or more rotors 224 driven by corresponding motors 222 to provide lift-off (or take-off) as well as other aerial movements (e.g., forward progression, ascension, descending, lateral movements, tilting, rotating, etc.). The drone 20 is illustrated as an example of a drone that may utilize various embodiments, but is not intended to imply or require that various embodiments are limited to rotor craft drones. Instead, various embodiments may be use with winged drones as well. Further, various embodiments may equally be used with land-based autonomous vehicles, water-borne autonomous vehicles, and space-based autonomous vehicles.

A rotor craft drone 20 may utilize motors 222 and corresponding rotors 224 for lifting off and providing aerial propulsion. For example, the drone 20 may be a “quad-copter” that is equipped with four motors 222 and corresponding rotors 224. The motors 222 may be coupled to the processor 230 and thus may be configured to receive operating instructions or signals from the processor 230. For example, the motors 222 may be configured to increase rotation speed of their corresponding rotors 224, etc. based on instructions received from the processor 230. In some embodiments, the motors 222 may be independently controlled by the processor 230 such that some rotors 224 may be engaged at different speeds, using different amounts of power, and/or providing different levels of output for moving the drone 20. For example, motors 222 on one side of the body 205 may be configured to cause their corresponding rotors 224 to spin at a higher rotations per minute (RPM) than rotors 224 on the opposite side of the body 205 in order to balance the drone 20 burdened with an off-centered payload.

The body 205 may include a power source 212 that may be coupled to and configured to power the various other components of the drone 20. For example, the power source 212 may be a rechargeable battery for providing power to operate the motors 222, the payload mechanism 221, and/or the units of the processor 230.

While the various components of the drone 20 are illustrated (e.g., in FIG. 2) as separate components, some or all of the components (e.g., the body 205, the processor 230, the motors 222, and other elements) may be integrated together in a single device or unit, such as a system-on-chip. The drone 20 and elements thereof may also include other components not described.

Various embodiments may be implemented within a variety of drone mission controllers, a schematic representation of which is illustrated in FIG. 3 that is suitable for use with various embodiments. With reference to FIGS. 1-3, the drone mission controller 30 may be a mobile computing device, a ground station, a mobile telephony network base station (e.g., an eNodeB), a server, or another remote computing device that may provide navigation assistance and other information to one or more drones (e.g., the drone 20). Examples of mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1xRTT), and Universal Mobile Telecommunications Systems (UMTS). The drone mission controller 30 may be configured to establish network interface connections with other networks, such other broadcast system computers and servers, the Internet, the public switched telephone network, and/or a cellular data network.

The drone mission controller 30 may include a processor 301 for executing software instructions. The drone mission controller 30 may include a memory for storing code and data. For example, the memory 302 may store navigation data and other information that may be transmitted to a drone. In some embodiments, the drone mission controller 30 may communicate with a drone mission controller that provides the navigation information to the drone. The memory 302 may include one or more of random access memory (RAM), dynamic RAM (DRAM), static RAM (SRAM), read only memory (ROM), electrically erasable programmable ROM (EEPROM), or other types of non-transitory computer-readable storage media.

The drone mission controller 30 may include at least one network interface 304. The network interface 304 may be used to communicate with drones and other devices or vehicles over a communications network, such as a WWAN (e.g., a mobile telephony network) or a local area network (e.g., Wi-Fi). The network interface 304 may be connected to one or more antennas 306 to transmit and receive communication beams with the drones. The processor 301, in conjunction with the network interface 304, may form radio frequency (RF) communication beams using the antennas 306. The drone mission controller 30 may also include a power interface 305 for providing power to the drone mission controller 30. The drone mission controller 30 may include a bus 310 that connects the various components of the drone mission controller 30 together.

The drone mission controller 30 may also include various other components not described. For example, the drone mission controller 30 may include a number of processing components such as modems, transceivers, subscriber identification module (SIM) cards, additional processors, additional hard drives, universal serial bus (USB) ports, Ethernet ports, and/or other types of wired or wireless input/output ports, keyboard, mouse, speaker, microphone, display screen, touchscreen, and many other components known in the art.

In various embodiments, a drone (e.g., drone 20 in FIGS. 1 and 2) may transmit communications to or receive communications from a drone operations controller (e.g., 40), which may be implemented in a server 400 or other remote computing device, an example of which is illustrated in FIG. 4. With reference to FIGS. 1-4, the drone 20 may communicate with a drone operations controller server 400 regarding operational safety communications and/or payload communications. The drone operations controller server 400 may typically include a processor 401 coupled to volatile memory 402 and a large capacity nonvolatile memory, such as a disk drive 403. The drone operations controller server 400 may also include a floppy disc drive, compact disc (CD) or digital video disc (DVD) drive 406 coupled to the processor 401. The drone operations controller server 400 may also include network access ports 404 (or interfaces) coupled to the processor 401 for establishing data connections with a network (e.g., communication network 60), systems supported by the network (e.g., the Internet) and/or other remote computing devices and servers. Similarly, the drone operations controller server 400 may include additional access ports, such as USB, Firewire, Thunderbolt, and the like for coupling to peripherals, external memory, or other devices.

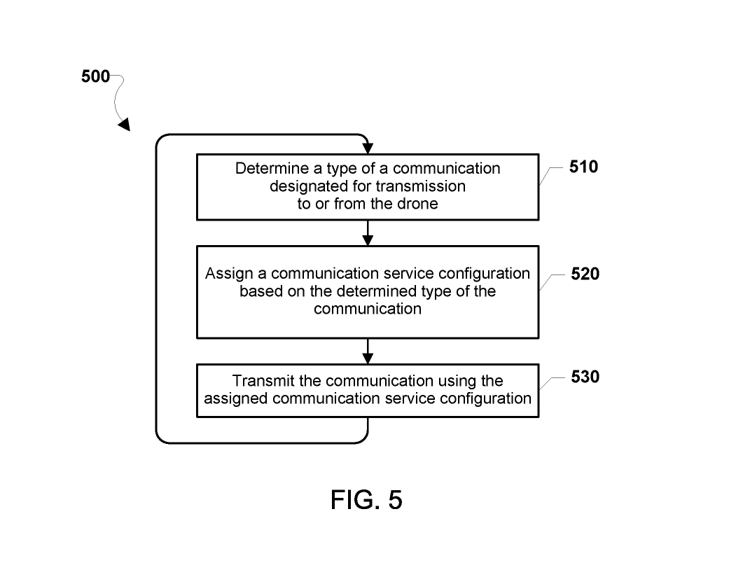

FIG. 5 illustrates a method 500 for managing network communication of a drone according to various embodiments. With reference to FIGS. 1-5, the operations of the method 500 may be performed by a processor (e.g., the processor 230 of the drone 20, the processor 301 of the drone mission controller 30, the processor 401 of the drone operations controller server 400, other remote computing device, or combinations thereof).

In block 510, the processor may determine a type of a communication designated for transmission to or from the drone. The determined type of the communication may be one of at least two types of communications, including a first type of communications for operational safety communications and a second type of communications for payload communications. The communications may be differentiated by labeling in data carried by the communications. For example, the data within the communication may include a designation or indication (e.g., a flag within packet header information) that may be used to determine the classification for the communication designated for transmission. In some embodiments, different applications either running on the drone or generating data transmitted to the drone may use different protocols, which may be distinguished and used to determine the type of the communication designated for transmission. In some embodiments, the drone may use separate SIMs for handling the different types of communications (e.g., Dual-Sim Dual-standby mobile communications). In this way, the SIM used for a particular communication may determine the type of the communication designated for transmission.

In block 520, the processor may assign a communication service configuration based on the determined type of the communication designated for transmission. The processor may assign a first configuration in response to the determined type of the communication being the first type of communications, and assign a second configuration different from the first configuration in response to the determined type of the communication being the second type of communications. The different communication service configurations may include different QoS designations. In this way, different types of communications may having different priority levels using prioritized scheduling, overlay/punctured resource scheduling, and/or multi-cell coordination.

In some embodiments, in assigning communication service configurations in block 520, the processor may assign first security credentials for the first type of communications different from second security credentials corresponding to the second type of communications. Additionally or alternatively, as part of assigning communication service configurations, the processor may assign a first authentication mechanism for the first type of communications different from a second authentication mechanism corresponding to the second type of communications. For example, a drone operator (e.g., operator 5) and a drone (e.g., drone 20) may exchange a first type of communications relating exclusively or almost exclusively to payload communications (e.g., navigational commands, telemetry, sensor, video, and/or other payload data) that use the first security credentials and/or the first authentication mechanism. In contrast, a centralized management regulator, an unmanned traffic manager, or a network service technician/inspector may exchange a second type of communications relating to operational safety communications (e.g., flight clearances and/or restrictions) that use the second security credentials and/or the second authentication mechanism.

Although the security credentials and/or the authentication mechanism may be different, the two different types of communications may or may not use different communication technologies, channels, frequencies, bands, and/or QoS designations. Also, the data exchanged using the two different types of communications may or may not be mutually exclusive.

Security credentials may be data that a communicating party uses, like a key or access code, to gain access to data or communications with the drone. Security credentials fall into categories such as, a) information known or supplied by the communicating entity (e.g., a mother's maiden name, a password, an answer to a security question, or other text-based communication); b) an access code stored and provided by the communicating entity (e.g., a Secure-ID passkey or other digital security credential); or c) data derived from a physical or biometric feature presented by the communicating entity (e.g., a retinal, fingerprint, or palm scan).

An authentication mechanism may define rules about security information, such as when, how, or whether a security credential may be used, the steps used for exchanging security credentials, and the format of how security information is stored in security credentials. An authentication mechanism may include a secure key exchange, a key validation, and/or a communication channel setup to enable credential tests. The authentication mechanism may include a password test (i.e., a simple mechanism), or a randomized split key method that prevents even the validator from knowing the root key (i.e., a complex mechanism). Also, when a key exchange process is employed, encryption may be used so an observer of the exchange cannot copy the key to use later. When a two-step process is employed, the validator may be required to pass two independent tests (e.g., a password test plus an emailed or short message service (SMS) messaged code for validating ownership of an account). The selection of authentication mechanism may take into account a desired level of authentication strength, which may be weighed against the computational loads, the communication loads, and the time to complete the authentication.

In assigning communication service configurations, the processor may also assign a first quality of service designation for the first type of communications different from a second quality of service designation for the second type of communications. Similarly, the processor may dedicate one or more communication resources to the transmission of the communications in order to increase the likelihood that the communications are successfully completed. The processor may assign a priority to one type of communications over another type of communications based on the determined type of the communication designated for transmission.

As used herein, the terms “quality of service” or “QoS” are used interchangeably to refer to a level of performance and/or priority guaranteed by resource reservation control mechanisms to a data flow in a packet-switched communications network. For example, a required bit rate, delay, jitter, packet dropping probability and/or bit error rate may be guaranteed. QoS guarantees are important if the network capacity is insufficient, especially for high-volume data exchanges, which are becoming increasingly common. Also, applications that require a fixed bit rate and/or are delay sensitive are particular about the QoS provided. The 5G telecommunications standard may distinguish priority information and include a “mission critical” category of information.

Using prioritized scheduling, a local transmitter (or processor controlling the local transmitter) may distinguish messages labeled with a certain designation (e.g., packet header information) and give those messages higher or lower priority accordingly in using radio resources. Thus, assigning communication service configurations may include assigning a priority to the communication over other communications based on the determined type of the communication. However, if there is an outstanding transmission, a processor managing the system may wait until that outstanding transmission is complete before the next high priority transmission is sent. Optionally, the local transmitter/processor may cancel a pending transmission in order to immediately send a high priority transmission, which may be reserved for only the highest of priority transmissions.

Using overlay or punctured resource scheduling involves using some or all of the resources needed for the outstanding transmission in order to insert the high priority transmission within or along with that outstanding transmission. In this way, the outstanding transmission is not completely canceled but is less likely to get through. The lower likelihood of completing the outstanding transmission may be acceptable in view of the need to transmit the high priority transmission.

Multi-cell coordination is a technique useful for future cellular networks. Multi-cell coordination techniques may be used to manage distributed radio resources. Strategies such as autonomous interference cognition, node cooperation, and network coding with dirty paper coding (DPC) may be used to optimize wireless network capacity. For example, when a processor determines a certain high level transmission needs to get through, commands may be communicated to the network so that resources of neighboring cells may be activated, redirected, or conserved in order to ensure or attempt to ensure network communications achieve certain standards (i.e., increasing the probability that a transmission gets through). Thus, transmitting the communication using the assigned communication service configuration may include transmitting a network message for activating multi-cell coordination configured to increase the likelihood that the communication is received by the drone, if transmitted to the drone, or received from the drone, if transmitted by the drone.

Alternatively or additionally, a processor of the drone may use resource management to shut down or lower the power usage of certain systems in order to ensure or increase the likelihood that a high priority transmission is successfully completed when being communicated. Lowering the power usage may be applied to specific frequency bands or sub-bands.

In block 530, the processor may transmit the communication using the assigned communication service configuration. Whether the transmission of the communication is to or from the drone (e.g., 20) may depend on whether the processor controlling the transmission is in the drone (e.g., processor 230), the drone mission controller (e.g., processor 301), the drone operations controller (e.g., processor 401) or another computing device.

The processor may periodically repeat the operations in blocks 510-530 to further manage network communication of the drone. Thus, the method 500 provides a way to manage network communications for one or more drones.

The various processors described herein may be any programmable microprocessor, microcomputer or multiple processor chip or chips that can be configured by software instructions (applications) to perform a variety of functions, including the functions of various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in processor-executable software, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read only memory (ROM), electrically erasable programmable ROM (EEPROM), FLASH memory, compact disc ROM (CD-ROM) or other optical disk storage, magnetic disk storage or other magnetic storage smart objects, or any other medium that may be used to store desired program code in the form of instructions or data structures and that may be accessed by a computer. Disk and disc, as used herein, includes CD, laser disc, optical disc, digital versatile disc (DVD), floppy disk, and Blu-ray disc where disks usually reproduce data magnetically, while discs reproduce data optically with lasers. Combinations of memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method of managing network communication of a drone, comprising:
determining a type of a communication designated for transmission to or from the drone, wherein the determined type of the communication is one of at least two types of communications including a first type of communications for operational safety communications and a second type of communications for payload communications;
assigning a communication service configuration based on the determined type of the communication; and
transmitting the communication designated for transmission to or from the drone using the assigned communication service configuration.

2. The method of claim 1, wherein the assigned communication service configuration includes a first quality of service designation for the first type of communications and a second quality of service designation for the second type of communications.

3. The method of claim 1, wherein assigning the communication service configuration comprises dedicating one or more communication resources to the transmission of the communication in order to increase a likelihood the communication is successfully completed.

4. The method of claim 1, wherein assigning the communication service configuration comprises assigning a priority to the first type of communications over the second type of communications based on the determined type of the communication.

5. The method of claim 1, wherein the drone is configured to use a single radio for transmitting both of the at least two types of communications.

6. The method of claim 1, wherein determining the type of the communication designated for transmission comprises identifying data within the communication that indicates the type of the communication.

7. The method of claim 1, wherein determining the type of the communication designated for transmission comprises identifying an application associated with the communication that indicates the type of the communication.

8. The method of claim 1, wherein transmitting the communication using the assigned communication service configuration comprises using prioritized scheduling giving the communication a first level of priority in response to the determined type of the communication being the first type of communications, and giving the communication a second level of priority different from the first level of priority in response to the determined type of the communication being the second type of communications.

9. The method of claim 1, wherein transmitting the communication using the assigned communication service configuration comprises using punctured resource scheduling that inserts the communication within or along with an in-progress transmission.

10. The method of claim 1, wherein transmitting the communication using the assigned communication service configuration comprises transmitting a network message for activating multi-cell coordination configured to increase a likelihood the communication is received by the drone, if transmitted to the drone, or received from the drone, if transmitted from the drone.

11. The method of claim 1, wherein the assigned communication service configuration is a first configuration in response to the determined type of the communication being the first type of communications, and is a second configuration different from the first configuration in response to the determined type of the communication being the second type of communications, wherein the first configuration includes at least one of a first authentication mechanism or first security credentials and the second configuration includes at least one of a second authentication mechanism or second security credentials.

12. The method of claim 11, wherein the assigned communication service configuration includes the first authentication mechanism, and wherein the first authentication mechanism includes at least one of a secure key exchange, a key validation, or a communication channel setup for credential tests.

13. The method of claim 11, wherein the assigned communication service configuration includes the first authentication mechanism, and wherein the first authentication mechanism includes a randomized split key.

14. A computing device, comprising:
means for determining a type of a communication designated for transmission to or from a drone, wherein the determined type of the communication is one of at least two types of communications including a first type of communications for operational safety communications and a second type of communications for payload communications;
means for assigning a communication service configuration based on the determined type of the communication; and
means for transmitting the communication designated for transmission to or from the drone using the assigned communication service configuration.

15. The computing device of claim 14, wherein means for assigning the communication service configuration assigns a first configuration in response to the determined type of the communication being the first type of communications, and assigns a second configuration different from the first configuration in response to the determined type of the communication being the second type of communications, wherein the first configuration includes at least one of a first authentication mechanism or first security credentials and the second configuration includes at least one of a second authentication mechanism or second security credentials.

16. A computing device, comprising:
a transceiver configured to communicate with a drone; and
a processor coupled to the transceiver and configured with processor-executable instructions to:
determine a type of a communication designated for transmission to the drone, wherein the determined type of the communication is one of at least two types of communications including a first type of communications for operational safety communications and a second type of communications for payload communications;
assign a communication service configuration based on the determined type of the communication; and
transmit the communication designated for transmission via the transceiver to the drone using the assigned communication service configuration.

17. The computing device of claim 16, wherein the processor is further configured with the processor-executable instructions to assign the communication service configuration as at least one of:
a first quality of service designation for the first type of communications and a second quality of service designation for the second type of communications;
one or more communication resources dedicated for the transmission of the communication in order to increase a likelihood the communication is successfully completed; or
a priority to the first type of communications over the second type of communications based on the determined type of the communication.

18. The computing device of claim 16, wherein the processor is further configured with the processor-executable instructions such that determining which type of the at least two types of communications to classify the communication designated for transmission comprises at least one of:
identifying data within the communication that indicates the determined type of the communication; or
identifying an application associated with the communication that indicates the determined type of the communication.

19. The computing device of claim 16, wherein the processor is further configured with the processor-executable instructions transmit the communication via the transceiver to the drone using the assigned communication service configuration by at least one of:
using prioritized scheduling giving the communication a first level of priority in response to the determined type of the communication being the first type of communications, and giving the communication a second level of priority different from the first level of priority in response to the determined type of the communication being the second type of communications;
using punctured resource scheduling that inserts the communication within or along with an in-progress transmission; or
transmitting a network message for activating multi-cell coordination configured to increase a likelihood the communication is received by the drone, if transmitted to the drone, or received from the drone, if transmitted from the drone.

20. The computing device of claim 16, wherein the assigned communication service configuration is a first configuration, in response to the determined type of the communication being the first type of communications, and is a second configuration different from the first configuration, in response to the determined type of the communication being the second type of communications, wherein the first configuration includes at least one of a first authentication mechanism or first security credentials and the second configuration includes at least one of a second authentication mechanism or second security credentials.

21. The computing device of claim 16, wherein the processor is further configured with the processor-executable instructions such that the assigned communication service configuration includes a first authentication mechanism, wherein the first authentication mechanism includes at least one of a secure key exchange, a key validation, or a communication channel setup for credential tests.

22. A drone, comprising:
a transceiver configured to communicate with a remote computing device; and
a processor coupled to the transceiver and configured with processor-executable instructions to:
determine a type of a communication designated for transmission from the drone, wherein the determined type of the communication is one of at least two types of communications including a first type of communications for operational safety communications and a second type of communications for payload communications;
assign a communication service configuration based on the determined type of the communication; and
transmit the communication designated for transmission via the transceiver to the remote computing device using the assigned communication service configuration.

23. The drone of claim 22, wherein the transceiver is capable of transmitting both of the at least two types of communications.

24. The drone of claim 22, wherein the processor is further configured with the processor-executable instructions to assign the communication service configuration includes as at least one of:
a first quality of service designation for the first type of communications and a second quality of service designation for the second type of communications;
one or more communication resources dedicated for the transmission of the communication in order to increase a likelihood the communication is successfully completed; or
a priority to the first type of communications over the second type of communications based on the determined type of the communication.

25. The drone of claim 22, wherein the processor is further configured with the processor-executable instructions to determine which type of at least two types of communications to classify the communication designated for transmission by:
identifying data within the communication that indicates the determined type of the communication; or
identifying an application associated with the communication that indicates the determined type of the communication.

26. The drone of claim 22, wherein the processor is further configured with the processor-executable instructions to transmit the communication via the transceiver to the remote computing device using the assigned communication service configuration by:
using prioritized scheduling giving the communication a first level of priority in response to the determined type of the communication being the first type of communications, and giving the communication a second level of priority different from the first level of priority in response to the determined type of the communication being the second type of communications;
using punctured resource scheduling that inserts the communication within or along with an in-progress transmission; or
transmitting a network message for activating multi-cell coordination configured to increase a likelihood the communication is received by the drone, if transmitted to the drone, or received from the drone, if transmitted from the drone.

27. The drone of claim 22, wherein the processor is further configured with the processor-executable instructions such that the assigned communication service configuration is a first configuration, in response to the determined type of the communication being the first type of communications, and is a second configuration different from the first configuration, in response to the determined type of the communication being the second type of communications, wherein the first configuration includes at least one of a first authentication mechanism or first security credentials and the second configuration includes at least one of a second authentication mechanism or second security credentials.

28. The drone of claim 22, wherein the processor is further configured with the processor-executable instructions such that the assigned communication service configuration includes a first authentication mechanism, wherein the first authentication mechanism includes at least one of a secure key exchange, a key validation, or a communication channel setup for credential tests.
